(19) United States
(12) Patent Application Publication
(10) Pub. No.: US 2025/0315683 A1
(43) Pub. Date: Oct. 9, 2025

(54) ANALYSIS OF STRUCTURED DATA IN CHAINS OF REPEATABLE ACTIONS WITHIN AN ARTIFICIAL INTELLIGENCE-BASED AGENT ENVIRONMENT

(71) Applicant: AGBLOX, INC., IRVINE, CA (US)

(72) Inventors: SEAN FEEHAN, EDMONTON (CA); THOMAS N. BLAIR, IRVINE, CA (US); MYKOLA LUKASHCHUK, EINDHOVEN (NL); IURII GRYTSAI, CALGARY (CA); KIRILL RAKHMINOV HUGHES, WEST ORANGE, NJ (US); GREGORY BURLET, Edmonton (CA); SPYROS J. LAZARIS, LOS ANGELES, CA (US)

(21) Appl. No.: 19/172,425

(22) Filed: Apr. 7, 2025

Related U.S. Application Data
(60) Provisional application No. 63/575,595, filed on Apr. 5, 2024.
(60) Provisional application No. 63/639,620, filed on Apr. 27, 2024.

(51) Int. Cl. G06N 3/0895; G06N 5/04

(52) U.S. Cl. CPC G06N 3/0895; G06N 5/04

(57) ABSTRACT

A framework for machine learning modeling of structured data that includes one or more artificial intelligence-based agents. These artificial intelligence-based agents are configured to create and execute chains of repeatable actions to perform user-driven and user-defined workflows with a given problem set and identified outcomes. Structured data that has been processed is fed by the artificial intelligence-based agents to language models to formulate actions operate as tools for analyzing a problem set that can be chained together to address a given workflow, in one or more prompts for constructing and delivering the identified outcomes. Chains of repeatable actions for saved and utilized for additional workflows having similar problem sets, and executed based on pre-identified triggers.

### CROSS-REFERENCE TO RELATED PATENT APPLICATION(S)

This patent application claims priority to U.S. provisional patent application No. 63/575,595, filed on Apr. 5, 2024, and to U.S. provisional patent application No. 63/639,620, filed on Apr. 27, 2024, the contents of both of which are incorporated in its entirety herein. In accordance with 37 C.F.R. § 1.76, a claims of priority are included in an Application Data Sheet filed concurrently herewith.

### FIELD OF THE INVENTION

The present invention relates to the field of artificial intelligence. Specifically, the present invention relates to the development of chains of repeatable actions for customized artificial intelligence for analyzing structured data in applications of deep-learning algorithms in transformer models such as language models.

### BACKGROUND OF THE INVENTION

Artificial intelligence-based agents and agentic workflows that leverage emerging classes of sophisticated yet user-friendly artificial intelligence tools are quickly become instrumental for utility in enterprise environments. Among these emerging classes of artificial intelligence tools are transformer models that have brought natural language-based machine learning into mainstream application. Agents are built on top of, and leverage, these transformer models, and harness their power to automate workflows by executing actions for specific tasks.

Transformer models are a relatively new development in the field of artificial intelligence, where a neural network architecture utilizing deep learning algorithms is designed to understand relationships between words in a sentence or sequence for natural language processing. Language models are one implementation of such transformer models, where large datasets are used to train the neural network architecture to perform various natural language-based tasks such as text generation and summarization. Such language models represent an advanced development in the field of artificial intelligence, but lack effectiveness and utility in complex enterprise workflow environments. For example, language models struggle to comprehend and contextualize structured data in the form of raw numbers, which may typically be found within documents that include text, or within specific types of files such as .csv files.

Language models also have limited context windows. This means that they require contextualization and synthesization of large amounts of both structured and unstructured data into more useful datasets that can be used by the language models to enable artificial intelligence-based agents to generate a meaningful, use case-specific output.

Conventional methods for analyzing structured data within such artificial intelligence-based processing environments still rely on static algorithms with limited adaptability. These methods typically are unable to efficiently interpret complex relationships and patterns in multi-dimensional data frames. Furthermore, existing approaches rarely dynamic code generation or execution, leading to suboptimal inference capabilities.

There is an existing, further need not addressed by either the artificial intelligence tools discussed above or existing approaches for analyzing structured data for artificial intelligence-based agents to continually self-adjust to account for different types and amount of data that much be analyzed to produce the proper queries for language models that are used to generate particular outputs. Therefore there is a need in the art for additional approaches that enable more robust support for existing artificial intelligence tools to analyze structured data over time, either alone or together with unstructured data, to enable the context-specific responses in custom-prompted artificial intelligence-based agents. Effectively, artificial intelligence agents need to be able to continually self-adjust due to changing conditions and a continual ability to handle different types of data. There also remains a need in the art for tools then enable utilizing language models for enterprise-quality workflows to properly construct and feed a small context window for the language model, utilizing specific relevant data, rather than including a larger amount of unnecessary data.

Accordingly, there is a need in the art for advances in the use of language models for analyzing and leveraging custom data that includes specific, structured (whether found alone or with unstructured data) for generating more accurate, context-specific responses in artificial intelligence-based agents that utilize language models for enterprise workflows. There is a further need in the art for tools and techniques that enable artificial intelligence-based agents to self-adjust according to the needs of the particular output workflow for which it is being implemented.

### BRIEF SUMMARY OF THE INVENTION

The present invention is a framework for developing chains of repeatable actions in artificial intelligence-based agents for performing complex workflows. The framework of the present invention enables artificial intelligence-based agents to self-adjust by creating their own chains (or, series of automated actions or tasks). The framework combines machine learning models with flexible, adaptive techniques for structured data analysis and introduces agent chains to automate and optimize repeatable tasks. Furthermore, the artificial intelligence-based agents in these chains are capable of teaching themselves to write software code, based at least on data types and attributes being analyzed, that is necessary to process, analyze, and contextualize datasets provided to the model for generating particular enterprise-quality outputs.

Artificial intelligence-based agents in the framework of the present invention create agent chains to execute a repeatable and reliable set of actions to accomplish a given goal with a given set of data and inputs. A user working with artificial intelligence-based agents in this framework defines a problem set, including data, and desired outcomes. An agent then creates a chain of actions from a pre-specified set of actions to accomplish this goal.

The framework then integrates these agent chains to perform the sets of repeatable actions to achieve specific goals for a given workflow. Each chain consists of actions categorized into data retrieval (obtaining and importing data from various sources); data processing (cleaning, transforming, and analyzing the data): outcome construction (generating insights, predictions, reports, graphs, etc.); and outcome distribution (delivering results to specified locations or systems).

Each of these categories has a continually growing set of actions related to it. Actions can be added by a human developer or created by another artificial intelligence-based agent. Regardless, one or more of these categories involves integrating language models with artificial intelligence-based agents to perform the chains of repeatable actions. The framework of the present invention therefore also includes an integration of such models into the workflows performed by the artificial intelligence-based agents.

Data processing with this framework is accomplished at least in part by utilizing shape attributes of a data frame for effectively analyzing structured data. This enables improvements in the responses generated by artificial intelligence-based agents that are configured to analyze structured data in different forms. The framework of the present invention therefore provides, in one aspect thereof, an approach for enabling artificial intelligence-based agents to self-adjust to structured datasets by automatically writing its own code to create appropriate automated actions for handling structured data to arrive desired model outputs, when such data is ingested into the overall workflow environment.

Artificial intelligence-based agents are built on top of language models leverage the models' natural language understanding and reasoning capabilities to perform tasks, make decisions, and interact with data, APIs, and users. Language models help by processing inputs, planning multi-step tasks, and executing agent actions using external tools (e.g., Python scripts, databases, APIs) which are designed and provided by an underlying architecture supporting the artificial intelligence-based agents, and refine its outputs through self-correction and memory. Artificial intelligence-based agents in the framework of the present invention also utilize retrieval-augmented generation (RAG) for improved accuracy, integrate long-term memory for contextual understanding, and employ chains of repeatable actions for orchestrating complex workflows. Technologies such as LangChain, LangGraph, AutoGPT, pgVector, and other tools such as the open-source Model Context Protocol (MCP), enable efficient execution, making these agents ideal for automating structured data analysis, decision-making, and dynamic content generation.

Chains of repeatable actions may also be thought of as agents unto themselves. Therefore, the present invention contemplates multiple agents, each performing chains of repeatable actions, that may be chained together to perform workflows and execute tasks therein.

It is therefore one objective of the present invention to provide systems and methods of identifying and creating chains of actions in a machine learning-based data processing environment that includes artificial intelligence-based agents for performing user-driven workflows. It is another objective of the present invention to provide systems of methods of analyzing shape attributes of a data frame to accurately infer features and understand data context in structured data in such a machine learning-based data processing environment. It is another objective of the present invention to provide systems and methods of transforming particular data types for normalization and extraction of features in such a machine learning-based data processing environment. It is still another objective of the present invention to utilize such shape attributes and transformed data types to generate a custom data set for application to a language model to improve the ability to understand structured data in such a model. It is yet another objective of the present invention to enable an agentic chain of actions that allows a language model to create and execute self-written or automatically-generated dynamic deterministic code or programs to permit artificial intelligence-based agents to derive logical inferences from such a custom data set.

It is still another objective of the present invention to provide systems and methods of enabling an agent to self-adjust by automatically creating a chain of actions and then save that chain of actions for future application. It is a further objective of the present invention to provide systems and methods for improved adaptability and accuracy in structured data analysis in a machine learning-based data processing environment where artificial intelligence-based agents execute chains of actions for performing user-driven workflows.

It is still a further objective of the present invention to provide systems and methods for greater flexibility through automated data type transformation and code execution in a machine learning-based data processing environment where artificial intelligence-based agents execute chains of actions for performing user-driven workflows. It is yet a further objective of the present invention to provide systems and methods for enhanced inference capabilities by leveraging shape attributes and real-time code execution, in a machine learning-based data processing environment where artificial intelligence-based agents execute chains of actions for performing user-driven workflows. It is still a further objective of the present invention to provide systems and methods in which a high level of code quality and data output are realized due to the self-review and correction nature of the dynamically-generated and executed code, in a machine learning-based data processing environment where artificial intelligence-based agents execute chains of actions for performing user-driven workflows.

The framework of the present invention realizes these objectives, and others, to provide a substantial improvement over existing artificial intelligence and machine learning methods for performing enterprise workflows. The differences between the novel framework presented herein, and the existing art, enable automation of such workflows in enterprise settings with greater efficiency and higher precision. This difference makes a substantial difference over such existing tools, at least because they enable utilization of artificial intelligence-based based in highly complex enterprise settings where precision of outcomes is of high importance. They also present a substantial difference in that users of such artificial intelligence-based agents with the technology presented herein can realize substantial cost savings over existing tools. Still further, agentic chains also address social, technical, and security implications of deployment of artificial intelligence tools. Social risks include autonomy, privacy, control, and compliance. Technical risks addressed include accuracy, cost control, security (such as encryption, access controls, compliance guardrails, long-term memory, and tool use). Agentic chains, and self-adjusting agentic workflows using such chains, remediate these risks through interactive human involvement in designing outcomes of workflows and managing the interactions with language models by artificial intelligence-based agents.

Still further, the present invention enables agents to semantically retrieve data based upon the concept and intent therein, in conjunction with the workflow(s) being performed, or in other words, the meaning of what one is trying to retrieve from the heterogeneous data source. Prior generations of software were deterministic and syntactically driven, meaning when a data source or web site changed formats or navigation processes, the static, programmed, retrieval algorithm would stop working. Agent-based data collection using the artificial intelligence approaches herein allows the framework of the present invention to adapt to the changing nuances of human information.

Other objectives, embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a block diagram illustrating aspects of functional elements and modules comprising a framework for developing chains of repeatable actions in artificial intelligence-based agents for performing complex workflows according to the present invention; and

FIG. 2 is a flowchart illustrating steps in a process of performing the framework according to one aspect of the present invention.

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

The present invention provides as noted above a framework for developing chains of repeatable actions in artificial intelligence-based agents that are configured to perform complex workflows. The framework applies various machine learning techniques to analyze structured data (and data, such as unstructured data or temporal data) in a processing environment that invokes one or more of the artificial intelligence-based agents, wherein workflows are automatically executed by the artificial intelligence-based agents that are customized for specific data inputs and particular outputs. The framework is used to analyze shape attributes of data frames, and transform text-based representations into their data types (e.g., text to numeric or string to a date) to improve upon an analysis of the substantive content of a given data set, providing customized artificial intelligence-based agents with a broader understanding of the information they have been developed to process.

The framework of the present invention enables such customized artificial intelligence-based agents to derive logical inferences from data sets (such as those including difficult-to-analyze structured data in different forms, and text-based representations of numerical values and dates in unstructured documents), by applying the processed data to one or more language models that create custom data sets based on prompts that define the outcomes desired for the workflows. Logical inferences may also be derived using a native modeling environment that includes both knowledge graphs and a retrieval augmented (RAG) data architecture, in conjunctions with the one or more language models. The agents and language models create chains of repeatable actions to address the problem set, based on the custom data set, for given outcomes. The customized artificial intelligence-based develop and execute their own chains of highly-customized automated actions based on the workflows (relative to input data, user queries, and particular outputs) they are tasked with performing.

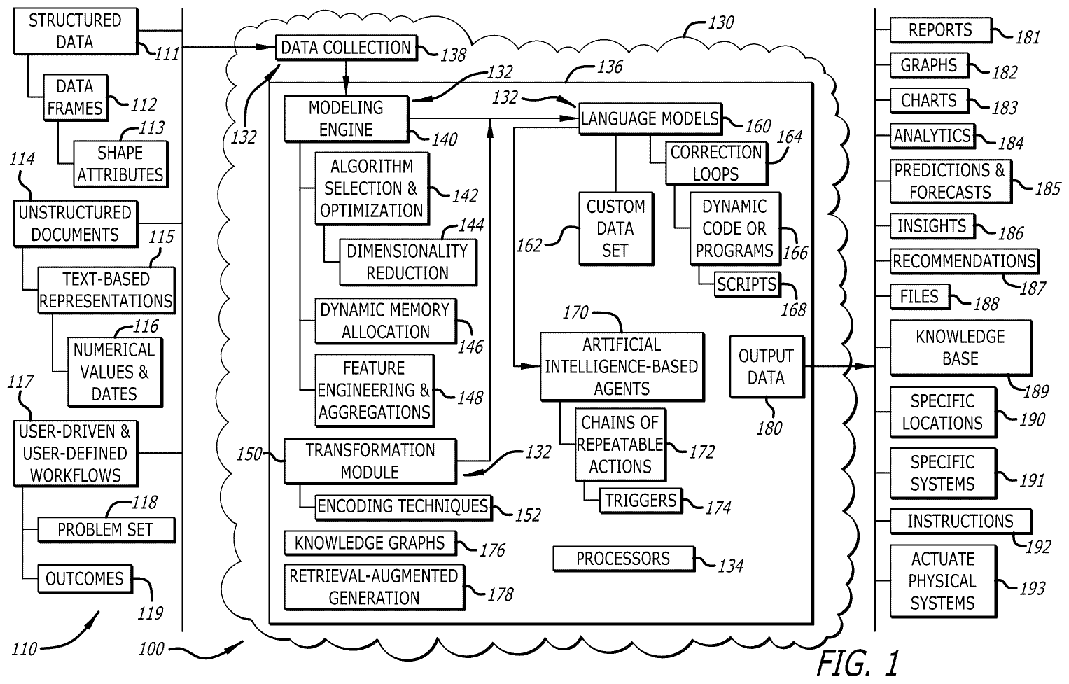

FIG. 1 is a systemic diagram illustrating various aspects of a framework 100 according to the present invention. The framework 100, and associated processing aspects therein, are embodied within one or more systems and/or methods that are performed in a plurality of data processing modules 132 and which are components within a computing environment 130. These data processing modules 132 may be configured to run within external cloud computing environments (and accessed therefrom by the framework), and also may be configured to run locally on devices hosting the framework, such as on mobile computing devices, “smart” phones, earphones or earbuds, on other wearable, internet-enabled devices such watches and eyeglasses, and in automotive platforms. Still further, one or more of the data processing modules 132 may be configured to run within, and executed on, edge computing environments and be responsive to natural language instructions, either verbal, written, or gesture-based. One or more processors 134 may be configured to execute program instructions or routines to perform the elements, modules, components, and functions described herein that together comprise and are embodied within the plurality of data processing modules. The words “module” and “modules” as used herein, may refer to (and the data processing modules may themselves comprise, at least in part) logic embodied in hardware or firmware, or to a collection of software instructions, written in a programming language, such as, for example, Java, Python, C, or assembly. One or more software instructions for such modules may be embedded in firmware. It will be appreciated that the functional data processing modules may include connected logic modules, such as gates and flip-flops, and may include programmable modules, such as programmable gate arrays or processors. The data processing modules described herein may be implemented as either software and/or hardware modules and may be stored in a storage device. It is to be additionally understood that the data processing modules, and the respective components of the present invention that together comprise the specifically-configured elements, may interchangeably be referred to as “components,” “modules,” “algorithms” (where appropriate), “engines,” “networks,” and any other similar term that is intended to indicate an element for carrying out a specific data processing function.

The plurality of data processing modules 132 define distinct activities and functions for processing input data 110 that represents a problem set 118 and a given goal in a desired outcome or outcomes 119 for a workflow 117. The input data 100 at least includes structured data 111 comprised of data frames 112 having one or more shape attributes 113 (such as, for example, columns and rows), and other information in unstructured documents 114, such as text-based representations 115 of numerical values and date values 116 therein. The framework 100 processes the structured data 111 and text-based representations 115 of numerical values and date values 116 in unstructured documents 114, by performing various mathematical calculations and executing various machine learning algorithms in the customized artificial intelligence-based agents 170. The framework 100 enables the customized artificial intelligence-based agents 170, working with one or more language models 160, to analyze custom data sets 162 representing the problem set 118 and identify, create, and execute chains of repeatable actions 172 that, when chained together, perform the user-driven, user-defined workflows 117.

The framework 100 enables the customized artificial intelligence-based agents 170 to ingest, receive, request, or otherwise obtain input data 110 of different types, and from different sources. The data processing modules 132 may include a data collection module 138 governing intake of the input data 110; for example, this may occur via one or more application programming interfaces (APIs) or via other interfaces designed to capture and provide input data 110 for the framework 100. Input data 110 may also be captured by an agent 170 itself, responsive to a chain of repeatable actions 172, and provide the input data 110 to the framework 100 for other artificial intelligence-based agents 170 to process.

The framework 100 also includes a machine learning-based processing environment 136, in which a modeling engine 140 is configured to analyze the structured data 111 and the data contained within unstructured documents 114. The framework 100 analyzes structured data 111 by taking advantage of shape attributes 113 of a data frame 112 to accurately analyze and draw inferences from structured data 111. This approach significantly improves the overall operation and analysis processes in structured data scenarios.

The framework 100 leverages a shape of a data frame 112 by breaking it down and into its structural characteristics, that specifically include the number of rows, columns, and overall dimensions. This enables an optimization data analysis and machine learning operations using the structured data 111. The shape is a tuple that denotes both rows and columns of data and can represent multiple dimensions, or features, of the structured data 111.

The modeling engine 140 of the framework 100 performs a multi-step analysis of the input data 110 using different machine learning-based data processing techniques, so that the artificial intelligence-based agents 170 are able to provide the one or more language models 160 with more accurate data and additional context. This enables the one or more language models 160 to better understand and use the data to provide desired outcomes 119 of a user-driven, user-defined workflow 117.

One such technique is algorithm selection and optimization 142. The present inventio selects an appropriate algorithm to reduce complexity in a data frame, as large, wide data frames (i.e. having many columns) may benefit from dimensionality reduction techniques 144 to reduce complexity before applying other machine learning models. Such dimensionality reduction techniques 144 include principal component analysis (PCA) and linear discriminant analysis (LDA). The modeling engine 140 may utilize Python libraries for these techniques when necessary, and the artificial intelligence-based agents 170 are also able to access and apply such techniques as part of chains of repeatable actions 172.

Narrow but deep data frames (in other words, fewer columns, and many rows) may be more suited for different techniques for reducing complexity, such as time series or sequential models. Regardless reducing complexity by analyzing shape attributes 113 enables the artificial intelligence-based agents 170 to properly select and limit the agent's actions that will be added to the action chain comprising the chain of repeatable actions 172.

Knowing the shape attributes 113 of a data frame 112 allows for dynamic memory allocation 146 and efficient data handling. This prevents crashes when working with large datasets. For small data frames, the modeling engine 140 may apply a more detailed analysis, while large frames may trigger batch processing or parallelization techniques. Regardless, the modeling engine 140 applies one or more techniques to dynamically allocate memory based on the shape attributes 113 of data frames 112 extracted from the structured data 111.

Dynamic memory allocation 146 may also include, and the framework 100 may utilize, techniques for storing information that is has extracted from input data 110. This may include, for example, a vector memory store for unstructured history, which is complementary to knowledge graphs 176 described herein. Such a vectorized memory store allows artificial intelligence-based agents 170 to remember conversations or past decisions for context, and may be particularly helpful when chains of repeatable actions 172 in artificial intelligence-based agents include conversational agents, such as chatbots.

The modeling engine 140 may also apply techniques for feature engineering and data aggregation 148. If, for example, a data frame 112 has many rows but few columns, the modeling engine 140 may prioritize row-wise operations (e.g., aggregations or time-based grouping). If, conversely, the data frame 112 has many columns, the modeling engine 140 may focus on identifying and removing redundant features or handling multicollinearity.

The machine learning-based processing environment 136 also includes a transformation module 150 for processing structured data 111 that appears in unstructured documents 114. The framework 100 transforms text-based representations 115 into appropriate data types (e.g., text to numeric or string to a date, in numerical/date values 116) to better analyze a substantive context and content of input data 110 in a given problem set 118. This provides the artificial intelligence-based agents 170 with a broader understanding of the information they are tasked with handling in a user-driven, user-defined workflow 117.

It is to be understood that data types may refer to a single data entry (for example, of a number or date), but may extend to lists, arrays, etc. The modeling engine 140 may also return such data in a particular format for such a data type, such as for example JSON (JavaScript Object Notation, which is a text-based format for storing and exchanging data. The artificial intelligence-based agents 170 may therefore transform data in unstructured documents 114 into either an actual data entry, or into a particular format representing such data.

Extraction, and normalization, of data in unstructured documents 114 is a key factor in limiting the input data 110 to contextually significant elements that can then be fit within a context window (token limit) of the one or more language models 160 that are being utilized. This is performed in a multi-step process at task (or, action) structuring time, instead of at execution time. This allows the framework 100 to be used to build scalable tasks as chains of repeatable actions.

The transformation module 150 performs this multi-step process, which includes first detecting text-based representations of numerical or date values 115, and converting them into their appropriate data types. The transformation module 150 applies custom encoding techniques 152 (e.g., one-hot encoding, label encoding, binary encoding, etc.) to categorical data detected in the text-based representations 115. One-hot encoding—one of the custom encoding techniques 152—is used in machine learning to convert categorical variables into a numerical format. One-hot encoding creates binary columns for each category, making the data compatible with language models 160 that require numerical input. The transformation module 150 may also invoke one or more language models 160 to recognize patterns or semantic meanings in textual data, enabling more accurate type conversions and improved feature extraction.

Structured data 111 occurs in a form that already provides more certain information, as compared to data that is numerical that is represented in unstructured documents 114. In structured data 111, all data points are clearly labeled, usually with a name and data in formats such CSV, JSON, YAML, etc. (for example, in spreadsheets and databases). These are all examples of structured data 111.

Unstructured documents 114 contain data that may be more nebulous than standard or straightforward structured data 111. This may occur, for example, in emails, Word documents, text messages, meeting recordings, etc. These contain textual representations 115 of numerical and date values 116, for example, which represent noise such that information must first be extracted to obtain data that the framework 100 is able to process.

With unstructured documents 114, the framework 100 must first pull out or extract the relevant data points, turn them into structured data 111, then proceed with normalization, to prepare for processing in other machine learning tools within the machine learning-based processing environment 136. The framework 100 therefore extracts data from unstructured documents 114, applies techniques to ascertain internal structures (such as for example CSV, JSON, YAML, etc.) for the appropriate data type, then applies techniques to that newly-extracted structured data 111 to make it more understandable for the one or more language models 160.

As noted above, the framework 100 includes one or more language models 160 that operate in conjunction with artificial intelligence-based agents 170 to create the chains of repeatable actions 172 that are executed to perform user-driven, user-defined workflows 117. The one or more language models 160 are neural network-based transformer models, which include language models (such as large language models, or LLMs, and “small” language models). Distinctions between sizes of language models 160 are effectively ones of training data set size and of the number of parameters to train models and generate results from natural language queries. Regardless, and for ease of convenience, in the present specification, both large and small language models shall be referred to as language models 160, and it is to be understood that neither the claims nor the disclosure presented herewith shall be limited to a language model 160 of any particular size or type.

Language models 160 are programs that are able to recognize and generate natural language in text, among other tasks. Regardless of size (small or large), language models 160 are built using machine learning techniques, such as the neural networks-based transformer models. Neural networks in such models include implementations of deep learning techniques for understanding natural language inputs and how characters, words, and sentences function together. Deep learning involves the probabilistic analysis of unstructured data, which eventually enables the neural network to recognize distinctions between pieces of content without human intervention.

Chains of repeatable actions 172 may, as noted above, also be saved and stored for future use where, for example, patterns in a problem set similar to those that have been processed are detected. Actions that qualify for a chain are decided upon at chain-construction time; the code for the action, and chain that links the actions together, is written and verified, then performed over and over and over again as long as those actions remain valid. Chains of repeatable actions 172 may also be effectively fractal in nature, such that an action in one agent-chain acts as the bridge to, or initiation of, another agent-chain. This means that chains of repeatable actions 172 may have sub-chains, and further means that some actions may have if-then configurations that only call other sub-chains when necessary based on the features of a custom data set. Each of these chains of repeatable actions, and sub-chains also comprising repeatable actions, may be saved for performance in other use cases.

Chain of repeatable actions 172 (and any sub-chains that may be called by another chain) may also executed based on triggers 174. These triggers 174 may include time-based triggers, where chains 172 or (certain actions within chains 172) are executed at specific intervals or according to specific temporal schedules. Another type of trigger 174 is document-type processing, where specific chains 172 are performed on particular incoming document types. Customized triggers 174 are also possible, where user-defined or system-detected events act as the triggers 174 for chains 172 or particular actions within chains 172. New triggers 174 may also be added to a chain 172 by the artificial intelligence-based agents 170 as users need them, for example where a user provides a particular trigger 174 as input in a user-driven, user-defined workflow 117.

Both the modeling engine 140 and the transformation module 150 may leverage capabilities of both knowledge graphs 176, and a retrieval augmented architecture 178, that are also part of the machine learning-based processing environment 136 in the framework 100 of the present invention. The framework 100 implements knowledge graphs 176 to enable correlations of data points derived from structured data 111 (either from data frames 112 and shape attributes 113 thereof, or from unstructured documents 114) with additional information, and provide cross-references with different data sources and the ability to find and associate different content (such as companies, organizations, ideas, and people) based on aggregation of such information. This provides an augmentation for the one or more language models 160, and adds a layer of explainability to highly in-depth information discovery as to a specific topics, entity(ies), person(s), etc. as required to perform a user-driven, user-defined workflow 117.

Knowledge graphs 176 are approaches to data modeling that are comprised of large amounts of hyper-relational (highly interconnected) data. A knowledge graph 176 has two main components-nodes, or vertices, which represent objects, and edges which represent the connections between those nodes. Properties may also be assigned to the nodes and edges to complete the knowledge graph. Knowledge graphs 176 are generally directed graphs. Another way of conceptualizing this is as a directional “subject predicate object” relationship, where the precise semantics of the relationship are encoded.

Knowledge graphs 176 are highly extensible and applicable to many different scenarios where inference is desired. Many sources of data can intersect to form one large knowledge base where several algorithms reveal certain patterns, relationships, and general knowledge that would otherwise not be present if the data had remained in separate data collections. Knowledge graphs 176 provide the integrity and inferability of relational databases while maintaining the flexibility of document-based storage methods.

Knowledge graphs 176 in the framework 100 of the present invention therefore provide exploration of connections of between data points, such as those that may be derived from analyzing text-based representations 115 in unstructured documents 114. In addition, knowledge graphs 176 make data analytics stateful, by remembering people, conversations, and context over time and across different social, consumer, and enterprise environments where particular workflows 117 are required. Knowledge graphs 176, together with retrieval-augmented generation 178 techniques as described below, therefore enhance the performance of the chains of repeatable actions 172 that comprise tasks of the artificial intelligence-based agents 170.

In the framework 100 of the present invention, artificial intelligence-based agents 170 also utilize retrieval-augmented generation (RAG) 178 to improve accuracy and integrate long-term memory for contextual understanding of the information derived from processing of structured data 111. The framework 100 also leverages technologies such as LangChain, LangGraph, AutoGPT, pgVector, and other tools such as the open-source Model Context Protocol (MCP) to enable more efficient execution of calls by chains of repeatable actions 172 to a RAG 178 architecture. This allows the framework 100 to be well-suited for automating structured data analysis, decision-making, and dynamic content generation within the artificial intelligence-based agents 170, because tools such as LangChain, LangGraph, AutoGPT, pgVector, and MCP (and other such tools) in conjunction with RAG 178 technology enable the creation of agents that effectively self-teach and self-adjust to generate more accurate responses and empower artificial intelligence-based agents to create their own logical sequences of steps and determine what software code is required for specific data analysis tasks, essentially making the artificial intelligence-based agents self-sufficient in understanding and coding based on data characteristics. In this manner, artificial intelligence-based agents are able to automatically generate self-written dynamic deterministic code or programs 166, as noted herein and together with one or more language models 160, in response to learning requirements for specific data analysis tasks in a given workflow 117.

Machine learning tools such as those listed enhance the performance of artificial intelligence-based agents 170 by enabling both chaining of operations in agentic workflows, and enabling self-adjustment. Utilizing these tools in conjunction with language models 160, knowledge graphs 176, and RAG systems 178 enable both of those functions. LangChain, for example, utilizes a chain structure through which information may be passed, using memory, prompts, LLMs, and agents 170 to form chains. It is the artificial intelligence-based agents 170 which identify and form the chains of repeatable actions 172, and the machine learning tools which acts as the “highway” over which such chains are executed. Other tools, such as LangGraph, provide statefulness for complex workflows 117, using nodes, edges, and states to build connections with graphs. This enables self-adjustment through a robust statement management of chains of repeatable actions 172 by providing context awareness, with the ability to integrate feedback to assist in that self-adjustment of chains 172.

Utilization of a RAG 178 architecture in this framework 100, together with associated technologies such as those listed above, also enables improvements in tokenization of information at least for context windows of the one or more language models 160, at least because the RAG 178 architecture to retrieve semantic meaning text-based representations 115 in unstructured documents 114 as they pertain to numerical values and dates 116. The RAG 178 architecture also enables artificial intelligence-based agents 170 to enable chains 172 to look for certain data (for example, Q1 2024 revenue values) and save this as a specific data item.

It is to be understood that there are many types of retrieval-augmented generation for enhancing language models by incorporating an information retrieval mechanism. Whatever the architecture that is utilized to provide retrieval-augmented generation, it generally enables language models to access and utilize data beyond their original training set for more accurate and contextually relevant responses. One architecture that may be utilized by the framework 100 of the present invention is agentic retrieval-augmented generation, which enables agents to dynamically adjust retrieval strategies and refine outputs through feedback loops. Such an agentic RAG excels in complex reasoning tasks, and provides artificial intelligence-based agents 170 with tools to self-adjust as additional input data 110 comes into a framework 100.

Artificial intelligence-based agents 170 are, at their core, designed to perform the user-driven, user-defined workflows 117 by generating output data 180 that is used to deliver the outcomes 119 desired from such workflows 117. There are many examples of outcomes 119 that can manifest as output data 180 of the artificial intelligence-based agents 170.

Examples of outcomes 119 that may be realizations of output data 180 of artificial intelligence-based agents 170 within the framework 100 of the present invention include reports 181, which include text, graphs 182, charts 183, analytics 184, predictions and/or forecasts 185, and any insights 186 or recommendations 187 that may be generated from such outcomes as defined by a user for a workflow 117. These may also be generated in any type of file 188 that represents an outcome 119. Outcomes such as reports 181, graphs 182, charts 183, analytics 184, predictions and/or forecasts 185, and insights 186 recommendations 187 provide the ability for visualization of data trends in illustrative representations of such trends over specific specified time periods.

In one specific example, a business intelligence agent may be configured as an artificial intelligence-based agent 170; this business intelligence agent may generate, as output data 180, any of the information described above. In addition, such a business intelligence agent may generate a knowledge base 189 of enterprise information, organization for example by subject matter; a bot may be configured to enable users to ask questions of the knowledge base 189. In a specific example of such a business intelligence agent-generated knowledge base 189, a customer relationship management system may be linked to the framework 100, and a bot may be implemented (together with a specifically-trained language model 160) to ask questions of the knowledge base 189 that comprises information in the customer relationship management system.

Output data 180 may be provided, in addition to any type of file 188, to any location 190 or system 191. Instructions 192 may also be generated as output data 180 from artificial intelligence-based agents 170. These instructions 192 may be transmitted to actuate physical systems 193 as outcomes 119 of workflows 117. For example, artificial intelligence-based agents 170 may be configured to perform workflows 117 that determine and execute actions of a robot in response to certain input data 110, and therefore instructions 192 may be generated as output data 180 of artificial intelligence agents to cause a robot to perform a particular task. The robot is therefore a physical or mechanical system 193 that is actuated by the artificial intelligence-based agents 170.

Many examples of actuating physical systems 193 are possible and within the scope of the present invention. For example, chains of repeatable actions 172 may be instantiated in artificial intelligence-based agents 170 to perform auto-grading of exams or tests in an academic setting; to deliver particular files 188 to an external system for structuring a curriculum, also in an academic setting; to perform an activity such as drafting and sending an email based on a report of a financial asset (where the email system is the physical system); and to perform a physical activity such as opening or closing a door in response to some problem or task that needs resolution. Machines may also be actuated by artificial intelligence-based agents 170. Regardless, in such instances, a natural language prompt of one or more language models 160 may be incorporated based on the processed input data 110 to refine the response of the physical system 193 to be actuated.

In another example of an outcome 119 of a user-driven, user-defined workflow 117 of the framework 100 of the present invention, the one or more language models 160 are induced to create chains of repeatable actions 172 by an artificial intelligence agent(s) 170 for generating net asset value (NAV) reports for administrations of funds in the financial sector, such as funds created and managed by venture capital and private equity firms. In such a scenario, users define workflows 117 for such NAV reports, and the artificial intelligence-based agents create a chain or chains of repeatable actions 172 that rely on external data to produce a single chart about asset value over time. Chains 172 may also be created to model net asset value across different asset classes, allowing the artificial intelligence-based agents 170 to create an amalgamation report with net assets over time, and further to compare relative health of the portfolio across different industries/classes. In effect, such a scenario has chains of chains, where each chain of repeatable actions 172 is connected to, and feeds, information for a subsequent chain of repeatable actions 172. Still further, such artificial intelligence-based agents 170 may induce the one or more language models 160 to self-write dynamic deterministic code or programs 166 to analyze particular data points in a custom data set as they arise during analysis of fund performance and health for such NAV reports, and save actions giving rise to such self-written code as a separate chain of repeatable actions 172.

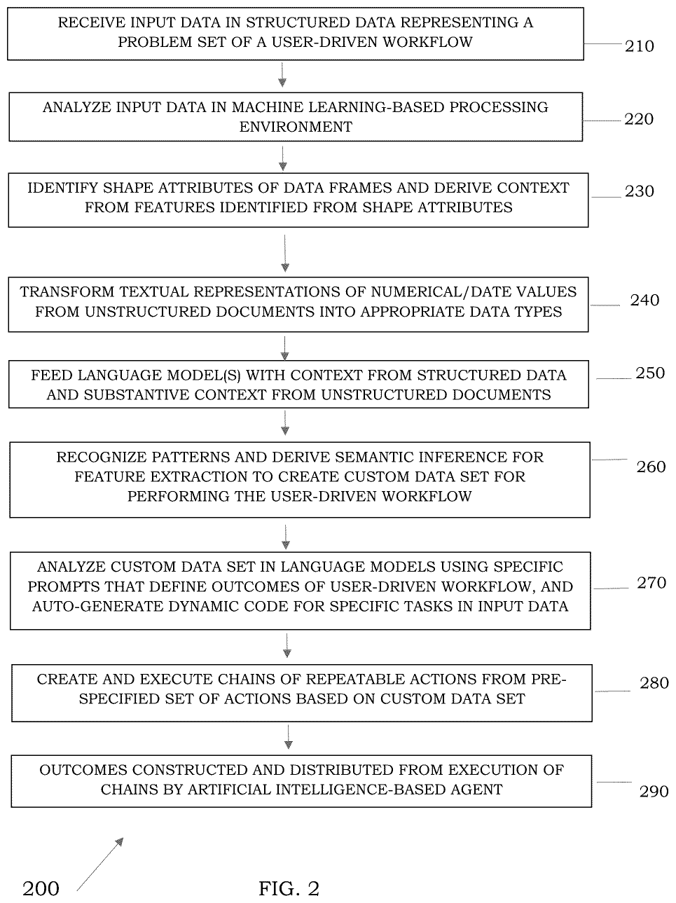

FIG. 2 is a flowchart illustrating steps in a process 200 of performing the framework 100 according to one aspect of the present invention. The framework 100 is in initialized by a user-driven, user-defined workflow 117 with a particular problem set defined by various types of input data 110, and having specifically-defined goals and outcomes 119. The process 200 is designed to create one or more chains of repeatable actions 172 from a pre-specified set of actions, or previously-built machine learning-based tools, that enable artificial intelligence-based agents 170 to accomplish the desired outcome(s) 119 of a particular user-driven, user-defined workflow 117.

At step 210, the process 200 begins receiving input data 110 comprised of structured data 111, in both structured form and unprocessed, text-based representations 115 of, for example, numerical values of data values 116. This input data 110 represents a problem set 118 of a user-driven, user-defined workflow 117. At step 220, this input data 110 is analyzed and processed in the machine learning-based processing environment 136 to define and execute the chains of repeatable actions 172 by the artificial intelligence-based agents 170.

At step 230, the process 200 identifies shape attributes 113 of data frames 112 in structured data 111, derives an initial context from features that are identified in the shape attributes 113. The process 200 also transforms textual representations 115 of numerical and data values 116 by processing unstructured documents 114 into their appropriate data types at step 240.

At step 250, at least one artificial intelligence-based agent 170 that has been instantiated to perform the user-driven, user-defined workflow 117 feeds one or more language models 160 with the context derived from the initial processing of the structured data 111 and from unstructured documents 114. At step 260, the one or more language models 160 recognize patterns and derive semantic inference for feature extraction, for example by leveraging one or both of knowledge graphs 176 and retrieval-augmented generation 178, to create a custom data set 162.

At step 270, the one or more language models 160 are then prompted to analyze the custom data set 162 in natural language prompts that provide definition and instruction for realizing the desired outcomes 119 of the user-driven, user-defined workflow 117. The prompts may include, for example, self-generated instructions that enable the one or more language models 160 to automatically general self-written dynamic deterministic code or programs 166, and automatically execute such deterministic code or programs 166, for performing specific tasks relative to the input data 110 and the desired outcome(s) 119.

Together, the artificial intelligence-based agents 170, and one or more language models 160, enable creation of chains of repeatable actions 172 in the process 200. At step 280, these chains 172 are created from pre-specified actions or tasks that are based on the custom data set 162, and executed to perform the user-driven, user-defined workflow 117. Pre-specified actions are pre-built machine learning-based tools that identified steps associated with processing particular types of data for particular outcomes 119, such as for example how to analyze quarterly revenue of a corporation in the example herein regarding net asset value reporting.

At step 290, the process 200 concludes by constructing and distributing outcomes 119 that are generated by execution of the chains of repeatable actions 172 by the artificial intelligence-based agents 170. The process 200 therefore is an integration of multiple tools and techniques within a machine learning-based processing environment 136 to generate more precise, context-aware responses to a given problem set 118, and with an innate ability to understand data characteristics and required analysis protocols to handle them to generate desired outcomes 119 to workflows 117.

The artificial intelligence-based agents 170 of the framework 100 of the present invention are capable, as noted above, of developing and executing self-written, automatically-generated dynamic deterministic code or programs 166 to perform specific steps in an analysis of particular types of data. This is one example of a chain of repeatable actions 172, in which the artificial intelligence-based agents 170 induce the one or more language models 160 to self-generate code to perform data analysis steps, thereby permitting artificial intelligence-based agents to further derive logical inferences from the custom data set 162 and further enhance its further enhances their analytical capabilities.

In this example, dynamic programming scripts 168, based on insights derived from the one or more language models 160 or user-defined parameters are automatically-generated and executed by the artificial intelligence-based agents 170. The framework 100 therefore is capable of executing self-written, or artificial intelligence-generated, dynamic deterministic code or programs 166 to manipulate or analyze the input data 110 in real time.

In this example, the one or more language models 160 and artificial intelligence-based agents incorporate external libraries and statistical models into the dynamically-generated and executed code for complex operations. The framework 100 also allows for self-correction by the one or more language models 160 in correction loops 164, providing the ability to inject a syntax error into the dynamic deterministic code or programs 166, and then feed the automatically-generated dynamic deterministic code or programs 166 back to the one or more language models 160 for correction and further context.

This may include identifying minimum and maximum ‘reliability’ factors for the one or more language models 160, which defines how many code correction loops 164 are allowed. This allows the artificial intelligence-based agents 170 to balance speed and code quality for different applications.

It is to be understood that automatically-generated dynamic deterministic code or programs 166 may be in any programming language. One example of such a programming language is Python, but it is to be further understood that such automatically-generated dynamic deterministic code or programs 166 need not be in the Python programming language. Other languages for software coding are also possible, and within the scope of the present invention. Therefore, automatically-generated dynamic deterministic code or programs 166 may be generated in any programming language by the one or more language models 160 and artificial intelligence agents 170, and neither this specification nor the claims is to be limited to any one particular type of programming language specifically mentioned herein.

Regardless, automatically-generated dynamic deterministic code or programs 166 is the result of prompting the one or more large language models 160 to generate such deterministic code or programs 166 to analysis particular elements of the custom data set 162. The one or more language models 160 may be trained to self-generate such prompts in a chain of repeatable actions 172 that have been saved when the artificial intelligence-based agents recognize a pattern or patterns in a new problem set that are the same as those in a custom data set 172.

In an example of implementation of such automatically-generated dynamic deterministic code or programs 166 in a chain of repeatable actions 172, artificial intelligence-based agents 170 may be configured to automate coding, caching, and configuration of applications for frequently-changing web or browser sections. This enables the artificial intelligence-based agents 170 to prompt the one or more language models 160 to automatically generate the deterministic code or programs 166 needed when a browser or website changes without notice, allowing data to be continually collected for the artificial intelligence-based agent 170 despite the change in browser/web page configuration.

The problem of changing browser or web interfaces can be explained as follows. When connecting to other platforms, certain software applications often rely on web-based or browser-based connection flows. However, these platforms regularly modify their user interfaces, causing frequent changes in the connection sequence or flow to such platforms for such software applications. These changes often interrupt services provided by such software applications that connect to these platforms, necessitating constant updates to the code of the software applications to modify their connection flows.

An example of such an issue occurs with online platforms that enable virtual meetings, such as Zoom™, Microsoft Teams™, or Google Meet™. Software applications that provide third-party services to such platforms often do so via web-based or browser-based interfaces. Connectivity via such a browser-based interface occurs in an ordered list of actions, such as for example “go to the url 1”, “press button X”, “fill field Y with Z”. Where the software application wants to connect to a meeting (using Zoom as an exemplary platform, the software application would perform actions such as open a browser and go to a link such as htt ps://zoom.us/, then press on a button to join a meeting, and so forth; but this list of actions can change if the platform (in this case, Zoom) decides to change its user interface.

Such changes require a constant monitoring of the user interface, and a re-write of the code of the software application trying to access a platform via such an interface, to ensure it is up to date with most recent user interface changes, every time such a change occurs. This is costly and time-consuming, and renders the software application unstable and unavailable until connection flows are fixed.

The framework 100 addresses this issue by enabling artificial intelligence-based agents to induce one or more language models 160 to determine which of their own code needs to be revised to address changes in user interfaces, and then automatically re-write that code. The artificial intelligence-based agents 170 prompt the one or more language models to generate and update code for sections of a web-based or browser-based user interface autonomously. Additionally, the artificial intelligence-based agents 170 save the resulting code changes in a configuration file or files as a chain of repeatable actions 172, to remember prior changes so that the artificial intelligence-based agents 170 only look for further changes to any sections of the user interface before initiating a connection flow.

The framework 100 therefore provides a self-healing approach to code for software as one example of a chain of repeatable actions 172, and combines this with a caching and storing paradigm to limit language model calls by the artificial intelligence-based agents 170. It is to be understood that this approach is not to be limited to applicability to web-based or browser-based interfaces for establishing connections between software applications and web-based platforms; instead, it is applicable to any situation where the one or more language models 160, in conjunction with artificial intelligence-based agents 170, recognize the need for dynamic deterministic code or programs 166 to automatically generated to solve a particular problem for a given user-driven workflow 117.

Such a self-healing approach is therefore not only for connecting with online meeting platforms, and neither is it only for instances where web-based or browser-based user interfaces are the obstacle to connectivity due to changes in such interfaces. Instead, the implementation of artificial intelligence-based agents with specifically-prompted language models 160 to self-write and/or self-revise code enable interactions that are applicable to connectivity generally between any software applications, regardless of whether either of those applications is web-based, and regardless of the approach to connectivity or communication or interaction or integration between such applications. Still further, the framework 100 may be applied to situations where code needs to be revised to integrate software application with hardware systems, such as where such hardware systems utilize particular devices.

In a further example of the application of such a self-healing approach, the framework 100 may implement such an approach to solve device driver conflicts between software applications and devices utilized by hardware systems.

The approach of the present invention also includes the ability to self-select and self-prompt a particular language model 160 based on the problem set 118 for a given workflow 117. For example, where one type or class of language models 160 is better at writing code for a particular use case where two or more software applications are connecting or integrating, the present invention includes the ability to autonomously select the most appropriate language model 160, and to self-generate one or more prompts for the most appropriate language model 160 to ultimate generate dynamic deterministic code or programs 166.

Returning more specifically to the example of a changing browser or web interface, the framework 100 is configured such that artificial intelligence-based agents 170 identify changes in a user interface that disables currently-configured deterministic connection flows and, utilizing specific prompts of a language model 160, autonomously determines what section of code is to be re-generated, and then autonomously writes the new section of the code. The artificial intelligence-based agents 170 are provided with inputs such as the current URL, page title, raw HTML content, and command history executed on the page, and subsequently generate commands to navigate the new connection flow.

The dynamic deterministic code or programs 166 automatically generated by the specifically-prompted language models 160 may then be executed deterministically in a process driven by one or more commands in one or more chains of repeatable actions 172. Commands may involve actions like navigating to a URL, clicking a button, or inputting text in a field. The process is repeated until a successful connection is established. The resulting changes in the deterministic code or programs 166 from the specifically-prompted language model 160 are then cached for efficient retrieval and utilization and saved as a chain of repeatable actions 172. The information in the changes to dynamic code that represent the steps in the language model's 160 button/page layout check of the web-based or browser-based user interface is stored in a configuration file, for example in JSON or YAML format (or other similar format). This may therefore itself be considered as a chain of repeatable actions 172.

Continuing with this example, the artificial intelligence-based agents 170 periodically update the connection flow by re-running the specifically-prompted language model 160 to accommodate for any new changes in the web-based or browser-based user interface of the platform being accessed.

In one embodiment of the present invention illustrating this exemplary approach, the software application is an artificial intelligence-based agents170 that attends and records an online meeting, and prepares an augmented transcription of the meeting's content. The augmented transcription includes a machine learning-based identification of speakers and population of a knowledge graph ??? based on the content and the identified speakers.

Previously, this artificial intelligence-based agent 170 might run a process in which it gets a signal to connect to a scheduled meeting, and then executes code to establish the connection. The code governs the bot by following a set path associated with a web page of the online meeting platform; but if the web page is changed, then the recording breaks and the bot's augmented transcription is not performed.

Using the approach of the present invention, an artificial intelligence-based agent 170 induces a language model 160 with a specific prompt periodically that goes to the hosting site of the online meeting platform (for example, a web page providing a meeting portal) and determines if there are any changes on the page, including how those changes work and how to click on all the appropriate buttons correctly. This language model 160 is then automatically prompted to self-write code to do the steps that it has determined for the changes to the web-or browser-based user interface of the online platform. The artificial intelligence-based agent 170 then runs this new code from the specifically-prompted language model 160 (representing a new connection flow) to establish the connection to the scheduled meeting by the artificial intelligence-based agent 170.

Subsequent instances of the artificial intelligence-based agent 170 attempting to connect to a scheduled meeting using the web-or browser-based user interface follow the agent-determined path from the chain of repeatable actions 172 that is recent and up to date; the artificial intelligence-based agent 170 also looks for whether any changes have been made. If the artificial intelligence-based agent 170 determines that the web page has changed, the artificial intelligence-based agent 170 identifies the changes and perform the process of writing revised deterministic code or programs 166 using the specifically-prompted language model 160.

The artificial intelligence-based agent 170 caches the updated code and stores the steps for a connection flow as a chain of repeatable actions 172, so that regardless of how many connections need to made every hour (which could be in the thousands) for the software application to access scheduled meetings, the software application is only making one call of the language model 160 for each platform being accessed.

Previously, for such software applications to address changes to web- or browser-based user interfaces, one would need to have backend software engineers write new code to repair the software application when it “breaks” due to changes to the platform's user interface. Such a process takes a lot of time (hours or even days) and the bot's ability to record and transcribe a meeting is unavailable. However, using the artificial intelligence-based agent 170 approach that implements a specifically- prompted language model 160 to self-diagnose and self-write dynamic deterministic code or programs 166, the language model 160 only needs to look at the web page and determine the clicks that are required for the changes to the user interface of the platform, so that the bot always connects.

The caching of revised code and storage of revised steps in a connection flow as a chain of repeatable actions 172 solves the problem of having to perform this check on every meeting connection, as this is very costly and results in slow connectivity. By performing the button/page layout check periodically using cached code, and storing the steps in the process of a connection flow in a JSON or YAML (or the like) configuration file as chain of repeatable actions 172, no matter how many connections the software application needs to make, the artificial intelligence-based agent 170 only needs one language model 160 call per platform (or very few calls per platform, as sometimes changes to web-based or browser-based user interfaces are made for different users and/or for users accessing the platform from different locations).

The artificial intelligence-based agent 170 operates in the following manner, according to one implementation of the framework 100 according to this example. For a given period of time, a bot's connection flow to record and transcribe a scheduled meeting follows some deterministic order of actions. A specifically-prompted language model 160 implemented by an artificial intelligence-based agent 170 according to the present invention to govern the bot's connection flow may start with:

You are an AI assistant that interprets the current browser
state and generates commands on what to do next.
Goal: Reach Zoom room number {number}
Current Page URL: {current_url}
Current Page Title: {current_title}
Current Page Content: {current_content}
Previous Command: {previous_command}
Previous Command Result: {previous_result}

In the above prompt, the fields {current_url}, {current_title}, {current_content}, {previous_command}, {previous_result} are similar to variables in classical programming that change dynamically, and may be described as follows:
{current_url}—values such as zoom.us, google.com, etc.;
{current_title}—represents change a header of the html page;
{current_content}—is the full raw text of the webpage on which the bot is currently on;
{previous_command}—is a last command that the bot generated; and
{previous_result}—is a way to implement feedback to the language model 160, to show it what its last command did (for example, the last command may have changed the webpage, or opened some window, or failed if the large language model generated invalid command to the browser).

The prompt of the language model 160 then continues with:

Based on the current browser state, page content,
and the result of the previous command,
provide the next command to execute.
The command should be a single line starting with a hyphen (-).
Use only the following commands:
- Goto <url>: Navigate to the specified URL,
- Click <selector>: Click on the element specified by
the CSS selector or text content.
- Type <selector>, <text>: Type the specified text into
the input field specified by the CSS
selector or label.
- Done: Indicates that the Zoom meeting page has been reached.
- Broken: Indicates that the Zoom meeting page is broken
and cannot be reached.

With this part, the possible generated text from the language model 160 is constrained to just a list of commands.

In the present invention, the language model 160 is responsible for generating text based on the provided prompt, which includes the browser context and previous interaction results. The language model 160 does not itself directly execute any commands or interact with the browser. Instead, the generated text from the language model 160 is analyzed to determine if it matches any predefined command patterns. If a valid command is recognized, such as
GOTO <url>or Click <selector>
   the execution of that command or commands represented by the newly-written deterministic code or programs 166 is subsequently handled by a separate component on the browser side, typically by a Python script 168 using a browser automation library such as Playwright or Selenium. Modern web browsers have code interfaces from which one can interact with the browser just by calling the browser API directly.

In other words, the language model 160 generates a command or commands from the revised code, and the artificial intelligence-based agent 170 confirms that these command or commands are valid. The artificial intelligence-based agent 170 then instructs the browser's interface to implement the newly-revised code, at which point the interface is directed via the Python script 168, to click the button based on the selector that language model 160 generated (it can find the button in the raw html text that was previously provided).

The changed result in the connection flow is then stored. The browser responds with the URL was changed Of the button <selector> was clicked and this browser response is stored into {previous_result}

The framework 100 then waits for the browser to update, and runs the prompt once again until either the language model 160 or the Python interface recognizes that the connection is completed successfully. For example, when a user connects to a Zoom™ meeting, he or she obtains a message in their browser console that you are connected to the Zoom meeting <number> when a successful connection has been established.

Where the language model 160 generates some text that cannot be recognized as one from the list of possible commands above, or a command that the language model 160 generates will lead to an error in the interaction of the browser and the Playwright interface, the bot would again use {previous_result}of the last command filled with text Unknown command: python cannot execute Of Failed command: {text of an error} and the prompt is re-run. The framework 100 therefore leverages the ability of language models 160 such as for example Anthropic's Claude3 and Meta's LLama3 to realize the goal (to connect the Zoom™ meeting) and realize that it's in a loop of consequential interaction with a deterministic system, which is achieved through the field {previous_result}

However, a prompt started only once can fail (for example, the language model 160 will take too much time or will stack in a loop of redirections). But because user interface changes often do not happen quickly, once at least one run of a prompt has succeeded, the artificial intelligence-based agent 170 stores what the language model 160 did, and uses this stored list of actions—a chain of repeatable actions 172—again without any need for further language model 160 calls or interactions.

The framework 100 may also, in a particular aspect of the present invention, be thought of as an artificial intelligence-based agent operating system that is designed to manage diverse types of input data 110, perform complex processing within one or more artificial intelligence models in a machine learning-based processing environment 136. Within this machine learning-based processing environment 136, a plurality of machine learning and artificial intelligence techniques are utilized to enable artificial intelligence-based agents 170 to create and execute chains of repeatable agents 172, which themselves may be considered as agents 170, and to enable artificial intelligence-based agents 170 to self-adjust and modify such chains 172 as different input data 110 is seen, and as nuances to user-driven, user-defined workflows 117 are introduced in problem sets 118 and desired outcomes 119 thereof.

In the framework 100, artificial intelligence-based agents 170 self-adjust at least through feedback learning and updating prompts for language models 160 based on such feedback learning. Feedback as a result of performance analysis of the artificial intelligence-based agents 170 is fed back into the machine learning-based processing environment 136, and includes re-prompting of language models 160, and integration one or both of the knowledge graphs 176 and the retrieval-augmented generation 178 architecture with information learned via the process of self-adjustment.

The artificial intelligence-based agents 170 may include a chain of repeatable actions 172 whose function is to monitor agentic performance and track an agent's decisions, at least for detection of anomalies. Agents 170 may therefore self-monitor for performance, data quality, and failure.

An artificial intelligence-based agent operating system within the framework 100 may also include a security or permission layer. In deployment, an artificial intelligence-based agent operating system may handle sensitive data and control external systems via APIs (such as for example actuating a physical system 193). A security layer for an artificial intelligence-based agent operating system manages access rights, performs controls for data privacy, and generally ensures compliance with different requirements.

In addition to the input data 110 listed above, it is to be understood that other types of input data 110 are also possible and within the scope of the present invention. Examples of other types of input data 110 include multi-modal inputs, such as audio data, image or visual data, and data captured by sensors or Internet-of-things devices, from which structured data 111 must be extracted. For example, the modeling engine 140 may include algorithms and techniques for performing image analysis and audio transcription, from which information may be extracted and analyzed for context.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, the present invention may incorporate different machine learning tools for enabling chaining and self-adjustment, depending on the particular data to be analyzed or the particular workflow 117 for which chains of repeatable agents 172 are constructed. Similarly, any type of language model may be utilized and this may itself be influenced by the particular data that is to be contextualized or the particular workflow 117 for which chains of repeatable agents 172 are constructed. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
ingesting input data that at least includes structured data that represents a problem set of a user-driven workflow;
analyzing the input data in a machine learning-based processing environment in which at least one artificial intelligence-based agent creates and performs chains of repeatable actions for the user-driven workflow, by:
identifying shape attributes of data frames in the structured data,
deriving a context from features in the structured data identified from the shape attributes of the data frames,
transforming text-based representations of numerical or date values from unstructured documents into their appropriate data types to analyze the substantive context in the unstructured documents; and
feeding one or more language models with the context from the structured data and the substantive context from the unstructured documents to recognize patterns and derive semantic inference for feature extraction, to create a custom data set representing the user-driven workflow, wherein the custom data set is applied to the one or more language models using one or more natural language prompts that define outcomes of the user-driven workflow; and
creating the chains of repeatable actions from a pre-specified set of actions based on the custom data set created by the one or more language models, and wherein the chains of repeatable actions are chained together to perform the user-driven workflow, and
wherein the outcomes are constructed and distributed from an execution of the chains of repeatable actions by the at least one artificial intelligence-based agent.

2. The method of claim 1, further comprising executing the chains of repeatable actions based on one or more triggers, the one or more triggers including time-based triggers, document type triggers, and custom triggers from user-defined or system-detected events.

3. The method of claim 1, further comprising inducing the one or more language models to create and execute automatically-generated dynamic deterministic code of data analysis steps to derive logical inferences from the custom data set, the automatically-generated dynamic deterministic code including auto-generated Python scripts based on the logical inferences and user-defined parameters that manipulate the custom data set in real time by incorporating external libraries and statistical models into the automatically-generated dynamic deterministic code.

4. The method of claim 3, further comprising injecting a syntax error into the automatically-generated dynamic deterministic code and feed the automatically- generated dynamic deterministic code back to the one or more language models for self-correction and for additional context in the custom data set in a code correction loop.

5. The method of claim 4, wherein minimum and maximum reliability factors are provided to the one or more language models to define a number of code correction loops that are allowed.

6. The method of claim 1, wherein the identifying the shape attributes enables defining and selecting actions that are added to the chains of repeatable actions for the artificial intelligence-based agent.

7. The method of claim 1, further comprising analyzing the shape attributes in a dimensionality reduction algorithm to reduce complexity before feeding the one or more language models, the dimensionality reduction algorithm including one or both of principal component analysis and linear discriminant analysis, wherein the shape attributes are tuples denoting rows and columns of data represent the features of the structured data.

8. The method of claim 7, wherein the deriving the context from the features further comprises dynamically allocating memory based on the features, and refining the features by aggregating data groupings and removing redundant features.

9. The method of claim 1, wherein the transforming the text-based representations of numerical or date values from the unstructured documents into their appropriate data types further comprises retrieving a semantic meaning of words relative to the numerical or date values from a retrieval augmented architecture, and applying the semantic meaning of words to one or more knowledge graphs, to refine the context of the custom data set prior to the feeding the one or more language models.

10. The method of claim 1, wherein the machine learning-based processing environment includes a machine learning modeling engine configured to determine the repeatable chain of actions based on the input data defining the problem set and the desired outcome of the user-driven workflow, the machine learning-based modeling engine providing the at least one artificial intelligence-based agent with a library of actions, the at least one artificial intelligence-based agent determining what actions to use in what order for each chain of repeatable actions, and wherein the output of the chain of repeatable actions is validated and iterated to reach the desired outcome of the user-driven workflow.

11. The method of claim 10, further comprising saving the chain of repeatable actions to a data store, so that an artificial intelligence-based agent is able to re- execute the chain of repeatable actions when another problem set having the same types of inputs and defining the same outputs is identified.

12. The method of claim 1, wherein the chains of repeatable actions enable the artificial intelligence-based agent to automatically normalize and extract an amount of the structured data that acts as a limiter of the problem set to contextually-significant features to fit within a token limit of the one or more language models.

13. A method, comprising:
analyzing structured data that represents a problem set of a user-driven workflow in at least one artificial intelligence-based agent that is configured to:
process structured data by identifying shape attributes of data frames in the structured data, and deriving a context from features in the structured data identified from the shape attributes of the data frames, and
analyze a substantive context in unstructured documents that have text-based representations of numerical or date values by transforming the text-based representations of numerical or date values into their appropriate data types;
creating a custom data set representing the user-driven workflow by feeding one or more language models with the context from the structured data and the substantive context from the unstructured documents to recognize patterns and derive semantic inference for feature extraction, wherein the custom data set is applied to the one or more language models using one or more natural language prompts that define outcomes of the user-driven workflow; and
identifying and creating chains of repeatable actions from a pre-specified set of actions to perform the user-driven workflow based on the custom data set, wherein the chains of repeatable actions are chained together to perform the user-driven workflow, and
wherein the outcomes are constructed and distributed from an execution of the chains of repeatable actions by the at least one artificial intelligence-based agent.

14. The method of claim 13, further comprising executing the chains of repeatable actions based on one or more triggers, the one or more triggers including time-based triggers, document type triggers, and custom triggers from user-defined or system-detected events.

15. The method of claim 13, further comprising inducing the one or more language models to create and execute automatically-generated dynamic deterministic code of data analysis steps to derive logical inferences from the custom data set, the automatically-generated dynamic Python code including auto-generated deterministic scripts based on the logical inferences and user-defined parameters that manipulate the custom data set in real time by incorporating external libraries and statistical models into the automatically-generated dynamic deterministic code.

16. The method of claim 15, further comprising injecting a syntax error into the automatically-generated dynamic deterministic code and feed the automatically-generated dynamic deterministic code back to the one or more language models for self-correction and for additional context in the custom data set in a code correction loop.

17. The method of claim 16, wherein minimum and maximum reliability factors are provided to the one or more language models to define a number of code correction loops that are allowed.

18. The method of claim 13, wherein the identifying shape attributes of data frames in the structured data enables defining and selecting actions that are added to the chains of repeatable actions for the artificial intelligence-based agent.

19. The method of claim 13, wherein the at least one artificial intelligence-based agent is further configured to analyze the shape attributes in a dimensionality reduction algorithm to reduce complexity before feeding the one or more language models, the dimensionality reduction algorithm including one or both of principal component analysis and linear discriminant analysis, wherein the shape attributes are tuples denoting rows and columns of data represent the features of the structured data.

20. The method of claim 19, wherein the deriving the context from the features further comprises dynamically allocating memory based on the features, and refining the features by aggregating data groupings and removing redundant features.

21. The method of claim 13, wherein the transforming the text-based representations of numerical or date values from the unstructured documents into their appropriate data types further comprises retrieving a semantic meaning of words relative to the numerical or date values from a retrieval augmented architecture, and applying the semantic meaning of words to one or more knowledge graphs, to refine the context of the custom data set prior to the feeding the one or more language models.

22. The method of claim 13, wherein a machine learning modeling engine is configured to determine the chain of repeatable chain actions based on the input data defining the problem set and the desired outcome of the user-driven workflow, the machine learning-based modeling engine providing the at least one artificial intelligence-based agent with a library of actions, the at least one artificial intelligence-based agent determining what actions to use in what order for each chain of repeatable actions, and wherein the output of the chain of repeatable actions is validated and iterated to reach the desired outcome of the user-driven workflow.

23. The method of claim 22, further comprising saving the chain of repeatable actions to a data store, so that an artificial intelligence-based agent is able to re-execute the chain of repeatable actions when another problem set having the same types of inputs and defining the same outputs is identified.

24. The method of claim 13, wherein the chains of repeatable actions enable the artificial intelligence-based agent to automatically normalize and extract an amount of the structured data that acts as a limiter of the problem set to contextually-significant features to fit within a token limit of the one or more language models.

25. A system, comprising:
a data collection module configured to ingest input data that at least includes structured data that represents a problem set of a user-driven workflow;
a machine learning-based processing environment configured to analyze the input data, in which at least one artificial intelligence-based agent creates and performs chains of repeatable actions for the user-driven workflow, by:
identifying shape attributes of data frames in the structured data,
deriving a context from features in the structured data identified from the shape attributes of the data frames,
transforming text-based representations of numerical or date values from unstructured documents into their appropriate data types to analyze the substantive context in the unstructured documents; and
one or more language models fed with the context from the structured data and the substantive context from the unstructured documents to recognize patterns and derive semantic inference for feature extraction, to create a custom data set representing the user-driven workflow, wherein the custom data set is applied to the one or more language models using one or more natural language prompts that define outcomes of the user-driven workflow,
wherein the chains of repeatable actions are created from a pre-specified set of actions based on the custom data set created by the one or more language models, and wherein the chains of repeatable actions are chained together to perform the user-driven workflow, and
wherein the outcomes are constructed and distributed from an execution of the chains of repeatable actions by the at least one artificial intelligence-based agent.

26. The system of claim 25, wherein the chains of repeatable actions are executed based on one or more triggers, the one or more triggers including time-based triggers, document type triggers, and custom triggers from user-defined or system-detected events.

27. The system of claim 25, wherein the one or more language models are induced to create and execute automatically-generated dynamic deterministic code of data analysis steps to derive logical inferences from the custom data set, the automatically-generated dynamic deterministic code including auto-generated deterministic scripts based on the logical inferences and user-defined parameters that manipulate the custom data set in real time by incorporating external libraries and statistical models into the automatically-generated dynamic deterministic code.

28. The system of claim 27, wherein a syntax error is injected into the automatically-generated dynamic deterministic code and feed the automatically-generated dynamic deterministic code back to the one or more language models for self-correction and for additional context in the custom data set in a code correction loop.

29. The system of claim 28, wherein minimum and maximum reliability factors are provided to the one or more language models to define a number of code correction loops that are allowed.

30. The system of claim 25, wherein an identification of the shape attributes enables defining and selecting actions that are added to the chains of repeatable actions for the artificial intelligence-based agent.

31. The system of claim 25, wherein the shape attributes are analyzed in a dimensionality reduction algorithm to reduce complexity before feeding the one or more language models, the dimensionality reduction algorithm including one or both of principal component analysis and linear discriminant analysis, wherein the shape attributes are tuples denoting rows and columns of data represent the features of the structured data.

32. The system of claim 31, wherein the context is derived by dynamically allocating memory based on the features, and refining the features by aggregating data groupings and removing redundant features.

33. The system of claim 25, wherein the transforming the text-based representations of numerical or date values from the unstructured documents into their appropriate data types further comprises retrieving a semantic meaning of words relative to the numerical or date values from a retrieval augmented architecture, and applying the semantic meaning of words to one or more knowledge graphs, to refine the context of the custom data set prior to the feeding the one or more language models.

34. The system of claim 25, wherein the machine learning-based processing environment includes a machine learning modeling engine configured to determine the repeatable chain of actions based on the input data defining the problem set and the desired outcome of the user-driven workflow, the machine learning-based modeling engine providing the at least one artificial intelligence-based agent with a library of actions, the at least one artificial intelligence-based agent determining what actions to use in what order for each chain of repeatable actions, and wherein the output of the chain of repeatable actions is validated and iterated to reach the desired outcome of the user-driven workflow.

35. The system of claim 34, wherein the chain of repeatable actions are saved to a data store, so that an artificial intelligence-based agent is able to re-execute the chain of repeatable actions when another problem set having the same types of inputs and defining the same outputs is identified.

36. The system of claim 25, wherein the chains of repeatable actions enable the artificial intelligence-based agent to automatically normalize and extract an amount of the structured data that acts as a limiter of the problem set to contextually-significant features to fit within a token limit of the one or more language models.
